(19) United States
(12) Patent Application Publication
(10) Pub. No.: US 2026/0349694 A1
(43) Pub. Date: Nov. 5, 2026

(54) Personality Based Rack Manager Deployment Through Cloud Based Management Appliance

(71) Applicant: American Megatrends International, LLC, Duluth, GA (US)

(72) Inventors: Chitrak Gupta, Johns Creek, GA (US); Muthukkumaran Ramalingam, Cumming, GA (US); Brian Vandecoevering, Morgan Hill, CA (US)

(21) Appl. No.: 19/194,440

(22) Filed: Apr. 30, 2025

(51) Int. Cl. G06F 8/60; G06F 21/10; H05K 7/14

(52) U.S. Cl. CPC G06F 8/60; G06F 21/105; H05K 7/1498

(57) ABSTRACT

In an aspect of the disclosure, a method, a computer-readable medium, and a computer system are provided. The computer system includes one or more computing devices. The one or more computing devices receive a selection of a hierarchical role from among a rack manager role, a row manager role, or a room manager role. The one or more computing devices identify, based on the selected hierarchical role, one or more features to be enabled in a management package. The one or more computing devices select, from a repository of microservices, a set of microservices corresponding to the identified one or more features. The one or more computing devices generate the management package by assembling the selected set of microservices. The one or more computing devices provide the management package for deployment in a data center environment according to the selected hierarchical role.

### FIELD

The present disclosure relates generally to computer systems, and more particularly, to techniques of generating and deploying personality-based management solutions for hierarchical data center rack environments.

### BACKGROUND

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v. 2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Data center management has traditionally focused on the individual server level, primarily through the use of BMCs. BMCs provide essential out-of-band management capabilities, allowing administrators to monitor server health, control power states, access console redirection, and perform basic maintenance tasks, often utilizing protocols like the Intelligent Platform Management Interface (IPMI). While effective for managing discrete servers, this approach becomes insufficient as data center infrastructure grows in complexity and density. The management scope of a typical BMC is limited to the server it resides on, lacking a holistic view or control over the broader rack environment which includes networking switches, power distribution units (PDUs), storage arrays, and increasingly sophisticated cooling systems.

As data centers evolved to support higher densities, diverse workloads like AI, and advanced technologies such as liquid cooling, the need for a more comprehensive management plane at the rack level became apparent. Early solutions attempting to address this need were often fragmented and specific to certain components or vendors. For instance, Top-of-Rack (TOR) switches might offer basic SNMP-based monitoring for network aspects, dedicated servers could be deployed solely for management tasks within a rack, or specialized appliances might provide IPMI-over-LAN or emerging Redfish capabilities for a subset of devices. Other approaches included cluster management software, BMC-based federation attempts, or specialized controllers for unique environments like immersion cooling tanks (CDU-based management). However, these solutions typically operated in silos, lacking integration and a unified management experience.

These existing rack management approaches suffered from several significant drawbacks that hindered efficient data center operations. The inherent technology heterogeneity within racks-combining compute, storage, networking, power, and cooling components from various manufacturers-made unified management difficult due to differing interfaces and capabilities. Deployment complexity was high, requiring configuration of multiple disparate systems. The reliance on non-standard protocols or inconsistent implementations of standards like Redfish created manageability challenges and limited interoperability. Furthermore, scaling these solutions beyond a single rack to manage rows or entire rooms effectively was often problematic, and the feature sets were generally fixed, lacking the flexibility to tailor management capabilities specifically to the diverse requirements of different rack configurations, deployment locations, or operational focuses (e.g., power optimization vs. compute node health).

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system includes one or more computing devices. The one or more computing devices receive a selection of a hierarchical role from among a rack manager role, a row manager role, or a room manager role. The one or more computing devices identify, based on the selected hierarchical role, one or more features to be enabled in a management package. The one or more computing devices select, from a repository of microservices, a set of microservices corresponding to the identified one or more features. The one or more computing devices generate the management package by assembling the selected set of microservices. The one or more computing devices provide the management package for deployment in a data center environment according to the selected hierarchical role.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a diagram illustrating a rack management system architecture showing the hierarchical relationship between data center management, rack manager, and various components managed at the rack level.

FIG. 3 is a diagram illustrating a cloud-based system for personality-based rack management deployment that addresses challenges of technology heterogeneity and deployment complexity in modern data centers.

FIG. 4 is a diagram illustrating the architecture of a personality-based microservices system for constructing and deploying rack manager instances.

FIG. 5 is a diagram showing the deployment options for a personality-based rack management system with different feature sets to address various data center requirements.

FIG. 6 is a flow chart illustrating a workflow for deploying a personality-based rack manager through a cloud-based service.

FIG. 7 is a diagram illustrating a hierarchical data center management system implementing the Rack, Row, Room management architecture.

FIG. 8 is a flow chart of a method for generating and providing a personality-based management package for a data center environment.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

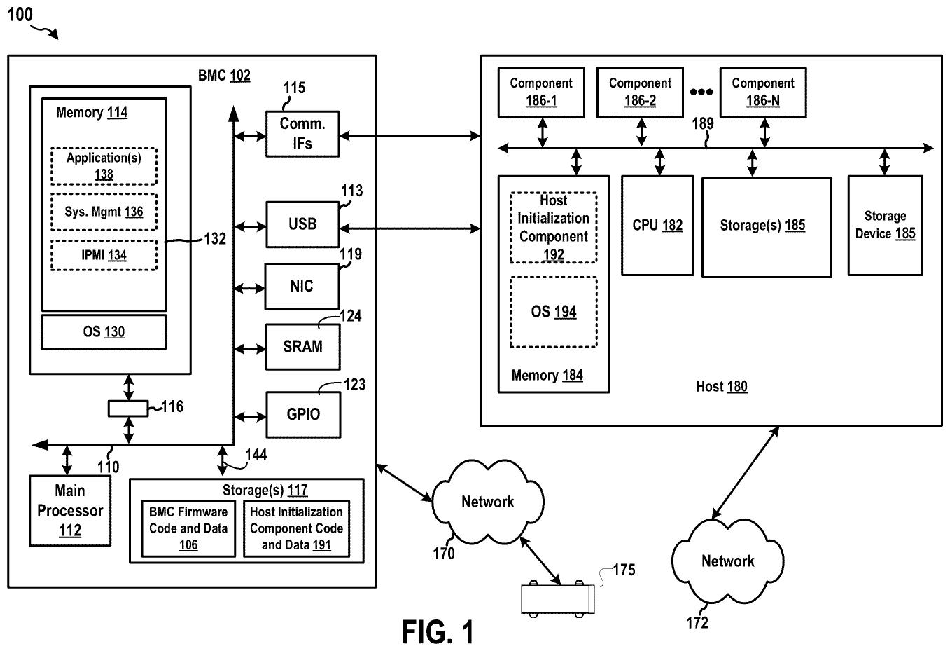

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

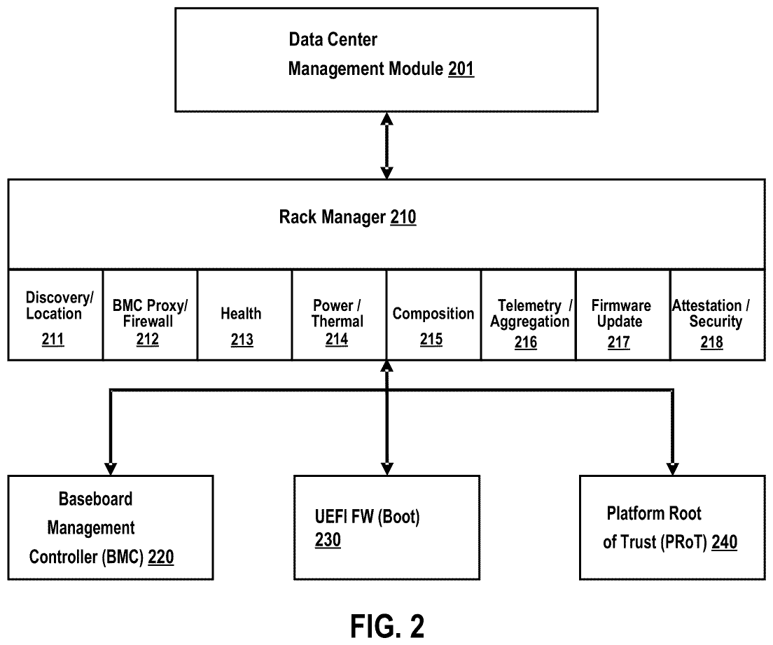

FIG. 2 is a diagram 200 illustrating a rack management system architecture. The diagram shows the hierarchical relationship between data center management module 201, rack manager 210, and various components managed at the rack level including the Baseboard Management Controller (BMC) 220, Unified Extensible Firmware Interface (UEFI) firmware 230, and Platform Root of Trust (PROT) 240.

The rack manager 210 serves as a higher-level management plane compared to the traditional BMC-level management described in FIG. 1. While the BMC 102 in FIG. 1 primarily manages a single server or node, the rack manager 210 in FIG. 2 is responsible for managing all infrastructure components within a rack, including compute nodes, networking equipment, storage devices, and/or cooling systems. This expanded management capability addresses the increasing complexity in modern data centers, particularly those with AI-based servers and liquid cooling systems.

The rack manager 210 includes several functional components that enable comprehensive rack-level management. The discovery/location component 211 identifies and locates all manageable devices within the rack. The BMC proxy/firewall component 212 provides secure communication with the BMCs of individual compute nodes, acting as an intermediary between the rack-level management and node-level management. The health component 213 monitors the overall health status of all rack components. The power/thermal component 214 manages power distribution, allocation, and thermal conditions throughout the rack, which is particularly important for high-density computing environments.

The composition component 215 handles the logical arrangement and organization of rack resources. The telemetry/aggregation component 216 collects and aggregates performance metrics and other telemetry data from all rack components, providing consolidated information to higher-level management systems. The firmware update component 217 manages the firmware update process for various components within the rack. The attestation/security component 218 ensures the security and integrity of the rack components through attestation and other security measures.

The rack manager 210 communicates bidirectionally with the data center management module 201, which represents a higher level in the management hierarchy. This hierarchical approach enables scalable management from individual racks to rows, rooms, and entire data centers. The data center management module 201 can coordinate activities across multiple rack managers, implementing data center-wide policies and collecting aggregated information from all managed racks.

The rack manager 210 also maintains bidirectional communication with the BMC 220, UEFI firmware 230, and PROT 240. These components represent different aspects of server management at the node level. The BMC 220, similar to the BMC 102 described in FIG. 1, provides out-of-band management capabilities for individual servers. The UEFI firmware 230 handles the initialization and boot process of servers, while the PROT 240 ensures secure boot and establishes a chain of trust for the system.

The rack manager 210 can be deployed in various ways depending on the specific requirements and constraints of the data center environment. That is, the rack manager 210 can be deployed with different personalities based on the specific requirements of the data center environment. These personalities determine the feature set, deployment location, and management focus of the rack manager. For instance, the rack manager 210 can be deployed on a Top-of-Rack (TOR) switch with a focus on network management, integrated into a power shelf with emphasis on power distribution management, implemented as a dedicated rack management server (using either x86 or ARM architecture) with comprehensive management capabilities, or even hosted on a DC-SCM controller or BMC with a more limited feature set. This flexibility addresses the challenge of technology heterogeneity in modern data centers by allowing the rack management solution to adapt to various deployment scenarios while maintaining a consistent management approach.

The rack manager 210 supports multiple management protocols to communicate with diverse rack components. These protocols may include Redfish for standardized RESTful APIs, IPMI for legacy systems, SNMP for network equipment, Modbus for power systems, and serial or SSH interfaces for direct command-line access. This multi-protocol support addresses the challenge of non-standard protocol manageability in heterogeneous rack environments.

The rack management system illustrated in FIG. 2 can be deployed with different feature sets based on specific requirements. These deployment options might range from a lightweight implementation focusing on basic aggregation, power, and thermal management to a comprehensive solution that includes advanced features like liquid cooling management and data visualization. This personality-based approach to rack management allows for customized solutions that address the specific needs of different data center environments while maintaining a common underlying architecture.

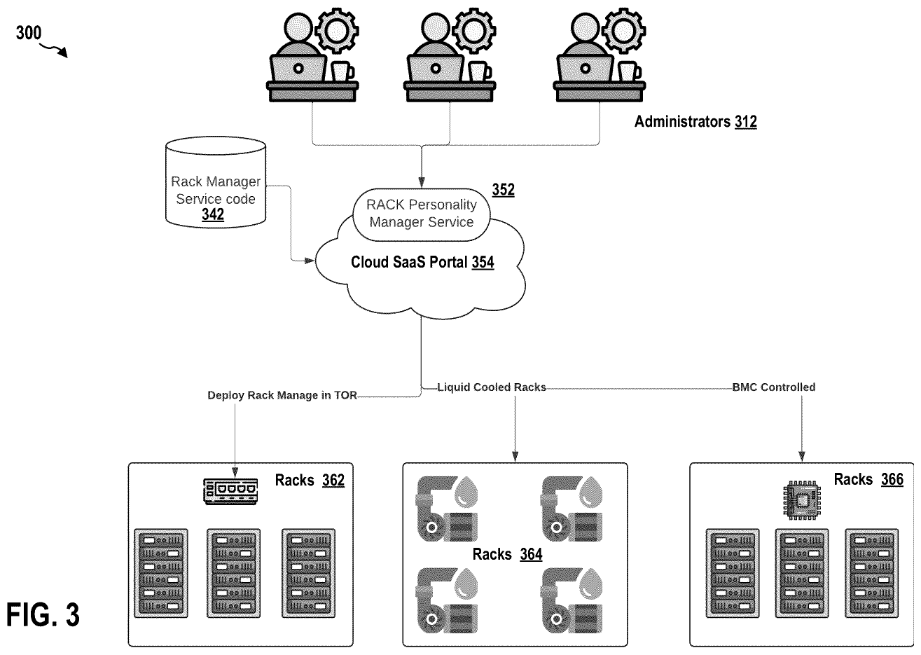

FIG. 3 is a diagram 300 illustrating a cloud-based system for personality-based rack management deployment. This system addresses the challenges of technology heterogeneity and deployment complexity in modern data centers by enabling customized rack management solutions tailored to specific data center requirements.

In this example, administrators 312 at workstations may configure and manage different types of rack infrastructures. These administrators interact with a cloud SaaS portal 354, which hosts a rack manager personality service 352. The rack manager personality service 352 functions as the central orchestration component that enables the creation and deployment of customized rack management solutions based on the specific personalities required for different rack environments.

Connected to the cloud infrastructure is a rack manager service code database 342, which constitutes the unified codebase repository from which different rack management personalities are derived. The service code contains modular, microservices-based components that can be selectively packaged and deployed based on the specific features and capabilities required for each deployment scenario. This approach maintains consistency in the underlying code while allowing for customization based on deployment requirements.

This example includes three deployment paths extending from the cloud service, representing different rack management personalities. The first path leads to racks 362, which are implemented on a TOR switch. This deployment personality would focus on network management, basic power monitoring, and standard rack operations.

The second path leads to racks 364, which are specialized rack deployments that incorporate liquid cooling technology. The rack management solution deployed to these systems would include features specific to monitoring and controlling liquid cooling infrastructure, such as coolant temperature monitoring, flow management, and specialized thermal controls.

The third path leads to racks 366, in which management is implemented through BMCs. This approach utilizes existing BMC infrastructure for rack-level management aggregation, with emphasis on server health monitoring, power management, and firmware update capabilities.

The personality-based approach to rack management allows for a flexible and adaptable solution that can be tailored to the specific needs of different data center environments. By understanding the personality of the data center and the rack-level manageability requirements, the system can enable and deliver the appropriate solution. This is particularly valuable in heterogeneous data center environments where different types of racks may require different management approaches.

The rack manager personality service 352 enables both the firmware provider and customer administrators to create rack management binaries tailored to specific deployment scenarios. Customers can request specific features and personalities for their rack managers based on their data center map and requirements. The entire source code remains consistent, but the personality of the rack management changes based on customer needs. This approach also facilitates feature licensing for different personalities and enables continuous updates through the cloud.

For example, if a customer requires server management capabilities, the rack manager solution can be focused on server management. Similarly, if a customer needs to manage liquid-cooled racks, the system can package liquid cooling-related features and capabilities. This flexibility allows the rack management solution to adapt to various deployment scenarios while maintaining a consistent management approach.

The workflow for deploying a personality-based rack manager typically involves logging into the cloud SaaS portal 354, selecting the rack manager product, choosing the deployment model (e.g., Out-of-Band, Lite, Full, or container-based), selecting the desired features based on the chosen deployment model, choosing the delivery model (e.g., binary or container), obtaining the appropriate license, automatically building the artifacts, and downloading and deploying them.

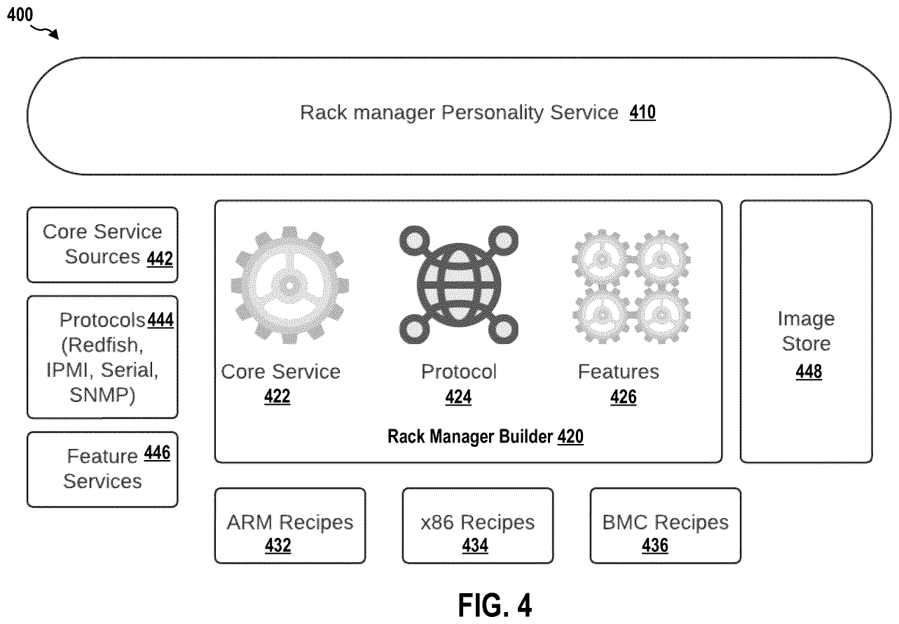

FIG. 4 is a diagram 400 illustrating the architecture of a personality-based microservices system for constructing and deploying rack manager instances, building upon the concepts introduced in FIG. 2 and FIG. 3. The system enables the creation of customized rack manager solutions tailored to specific deployment use cases or “personalities.”

In this example, a rack manager personality service 410 (similar to the rack manager personality service 352) may be accessed via the cloud SaaS portal 354 by administrators 312. The rack manager personality service 410 provides an interface for defining the desired characteristics of a rack manager instance. This includes selecting the target deployment environment (e.g., an x86 server, an ARM-based appliance, a TOR switch, a BMC, etc.), the specific features required (such as those listed in FIG. 2, like power/thermal management 214, compute node management, liquid cooling support, etc.), and the communication protocols needed to interact with the managed devices (e.g., Redfish, IPMI, SNMP, Modbus, Serial, SSH).

Based on the selections made via the rack manager personality service 410, a rack manager builder 420 orchestrates the construction of the specific rack manager instance. The rack manager builder 420 draws upon a set of source code repositories containing modular, microservice-based components. These include core service sources 442, which provide fundamental rack management functionalities; protocols sources 444, containing implementations for various management protocols like Redfish, IPMI, SNMP, etc.; and features services 446, which represent the individual, selectable capabilities of the rack manager (e.g., liquid cooling management, data visualization, specific device discovery methods).

More specifically, the core service sources 442 provide the foundational code that is common across all rack management deployments, regardless of personality. The protocols sources 444 contain implementations of various management protocols such as Redfish, IPMI, SNMP, Modbus, serial interfaces, and SSH. These protocols enable the rack manager to communicate with diverse rack components using their native management interfaces, addressing the challenge of protocol heterogeneity in modern data centers.

The features services 446 repository contains implementations of specific management capabilities that can be selectively included based on the requirements of a particular deployment. These features might include power management, thermal control, compute node management, network management, liquid cooling management, event logging, and data visualization, among others. The image store 448 contains pre-built images or templates that can be used as starting points for creating customized rack management solutions.

The rack manager builder 420 utilizes recipes, such as ARM recipes 432 and x86 recipes 434, which provide instructions specific to building an image for a particular operating environment or hardware platform. These recipes guide the selection, configuration, and integration of the necessary microservices from the source repositories (442, 444, 446) to create a functional rack manager image suited for the target deployment personality.

The output of the rack manager builder 420 is a deployable rack manager artifact. This artifact contains components of selected core service 422, implementations of necessary protocols 424, and features 426 that are chosen, packaged together. The artifact might be a firmware image, a set of binaries, or a container image, corresponding to the delivery models discussed previously. These generated artifacts may be stored in an image store 448, ready for download and deployment by the customer or administrator 312, as outlined in the workflow described in relation to FIG. 3.

For example, if a data center requires a rack management solution focused on liquid cooling management, the rack manager personality service 410 would instruct the rack manager builder 420 to include the core service 422, the appropriate protocols 424 for communicating with liquid cooling equipment, and the specific features 426 related to liquid cooling management. The resulting rack management solution would be optimized for managing liquid-cooled racks, with the necessary capabilities for monitoring coolant temperature, controlling flow rates, and managing thermal conditions.

Similarly, if a data center requires a rack management solution focused on network management, the rack manager personality service 410 would instruct the rack manager builder 420 to include the core service 422, the appropriate protocols 424 for communicating with network equipment (such as SNMP), and the specific features 426 related to network management. The resulting rack management solution would be optimized for managing network equipment within the rack, with capabilities for monitoring network traffic, managing switch configurations, and detecting network anomalies.

This microservices-based approach, managed by the rack manager personality service 410 and executed by the rack manager builder 420, provides significant flexibility. It allows the firmware provider or the customer to assemble rack managers with precisely the required capabilities for diverse environments, such as the TOR switch-based racks 362, liquid-cooled racks 364, or BMC-managed racks 366 shown in FIG. 3. Furthermore, this architecture facilitates easier upgrades and modifications; if a data center introduces new hardware or requires enhanced management capabilities, the personality can be updated through the rack manager personality service 410, triggering the rack manager builder 420 to generate a new artifact incorporating the necessary changes, potentially by adding or updating specific microservices from the features services 446 or protocols sources 444. This addresses the need for continuous updates and adaptability in evolving data center infrastructures.

Further, the microservices-based architecture allows for independent development and deployment of different rack management capabilities. Each management capability, whether related to compute nodes, liquid cooling systems, power components, or cooling components, is implemented as an independent microservice module within the core framework. This modular approach enables flexible composition of rack management solutions based on specific requirements, with the ability to add or remove capabilities as needed.

The rack manager builder service in the cloud platform is designed to allow end-users to select the specific features they want, obtain the appropriate license, and download the resulting artifacts as containers or binaries for deployment in their environment. This self-service approach simplifies the process of creating and deploying customized rack management solutions, reducing the complexity and time required to implement rack-level management. The layered approach to rack management, with the ability to pick and choose specific recipes for deployment, addresses the challenge of technology heterogeneity in modern data centers.

The rack manager 210, constructed and deployed according to the personality defined via the rack manager personality service 410, incorporates a range of features and supports multiple communication protocols to effectively manage diverse rack environments. These features, drawn from the features services 446 repository during the build process orchestrated by the rack manager builder 420, address specific management needs within the rack. An aggregated Application Programming Interface (API) model provides a unified management interface, often utilizing Redfish northbound communication, simplifying interaction for higher-level systems like the data center management module 201 or for administrators 312. This aggregation abstracts the complexity of managing individual components.

Specific management capabilities include rack power and rack thermal management, handled by functional blocks potentially corresponding to the power/thermal component 214. These features allow monitoring and control of power distribution units (PDUs), power shelves, and cooling systems (including fans and potentially liquid cooling infrastructure) within the rack, optimizing energy usage and maintaining suitable operating temperatures, which is particularly relevant for high-density compute environments or specialized deployments like the liquid-cooled racks 364. Compute node management enables the rack manager 210 to oversee individual servers within the rack, interacting with their respective BMCs, such as the BMC 220, possibly through the BMC proxy/firewall component 212, for tasks like health monitoring, power control, and firmware updates coordinated by the firmware update component 217.

Switch management capabilities allow the rack manager 210 to configure and monitor network switches, such as TOR switches, often found in rack deployments like the racks 362. For specialized environments, liquid cooling management features provide specific controls and monitoring for liquid cooling systems, addressing the unique thermal challenges of such deployments. The rack manager 210 also aggregates Event logs from various managed components, providing a centralized view of system events, potentially handled by the telemetry/aggregation component 216. A web user interface (Web UI) and data visualization tools may be included as features 426, offering graphical representations of rack status, telemetry data, and facilitating administrative tasks through a user-friendly interface, possibly accessed via the cloud SaaS portal 354 or locally.

To interact with the heterogeneous components within a rack, the rack manager 210 supports a variety of communication protocols, implementations of which are drawn from the protocols sources 444. Redfish is a primary protocol, used for both southbound communication with modern devices supporting the standard and northbound communication via the aggregated API. Support for Intelligent Platform Management Interface (IPMI) provides compatibility with legacy server management interfaces. Simple Network Management Protocol (SNMP) is included for managing network devices like switches. Modbus protocol support enables communication with power distribution and monitoring equipment. Furthermore, Serial and Secure Shell (SSH) protocols allow for direct, command-line based interaction with certain devices when needed. This multi-protocol capability, represented by the protocols 424 included in the built artifact, is fundamental to managing the diverse hardware often found in data center racks.

The final rack manager artifact, generated by the rack manager builder 420 based on the selected personality, features 426, and protocols 424, can be delivered in multiple formats to suit different deployment scenarios. It can be packaged as firmware, suitable for embedding directly onto hardware like a BMC 220, a switch controller, or a dedicated management appliance (e.g., using ARM recipes 432 or x86 recipes 434). Alternatively, it can be delivered as a binary package, allowing integration into existing management software stacks or operating systems on standard servers (e.g., x86-based). A container delivery option provides the rack manager as a container image (e.g., Docker), facilitating deployment in modern, containerized infrastructure environments. This flexibility in delivery models allows customers to choose the deployment method that best fits their operational practices and infrastructure, as selected through the workflow involving the cloud SaaS portal 354 and the rack manager personality service 410.

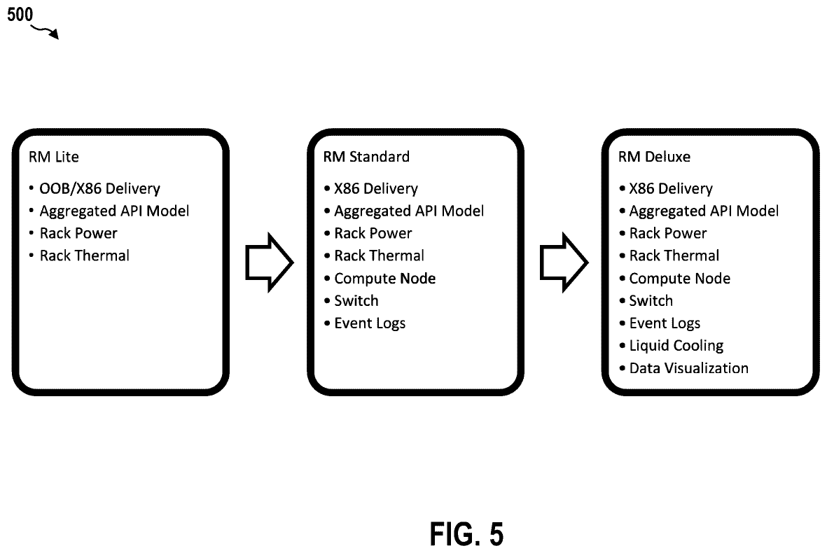

FIG. 5 illustrates a diagram 500 showing the deployment options for a personality-based rack management system. This figure expands upon the concepts introduced in FIG. 2, FIG. 3, and FIG. 4, providing a detailed view of how the rack manager can be deployed with different feature sets to address various data center requirements.

The rack management system can be deployed in multiple configurations, each tailored to specific customer needs and infrastructure requirements. These deployment options represent different “personalities” of the rack manager, with varying feature sets and delivery models. While the naming conventions presented here are for illustrative purposes and may be finalized by the business team, they demonstrate the flexibility of the personality-based approach to rack management.

The first deployment option shown in FIG. 5 is the Rack Manager Lite (RM Lite). This configuration is designed for environments requiring basic rack management capabilities. The RM Lite supports both Out-of-Band (OOB) and x86 delivery models, providing flexibility in how the rack manager is deployed. The feature set of the RM Lite includes an Aggregated API Model, which provides a unified interface for managing rack components, as well as Rack Power and Rack Thermal management capabilities. These features enable basic monitoring and control of power distribution and thermal conditions within the rack, which are used for maintaining proper operating conditions. The RM Lite represents a lightweight implementation that addresses fundamental rack management needs while minimizing resource requirements.

The second deployment option is the Rack Manager Standard (RM Standard). This configuration builds upon the capabilities of the RM Lite, offering a more comprehensive set of features for environments requiring more extensive rack management. The RM Standard is delivered via the x86 delivery model, which provides greater processing power and flexibility compared to the OOB option available in the RM Lite. In addition to the Aggregated API Model, Rack Power, and Rack Thermal management capabilities included in the RM Lite, the RM Standard adds Compute Node management, Switch management, and Event Logs. The Compute Node management feature enables the rack manager to oversee individual servers within the rack, interacting with their respective BMCs for tasks such as health monitoring, power control, and firmware updates. The Switch management capability allows the rack manager to configure and monitor network switches within the rack, while the Event Logs feature provides a centralized view of system events from various managed components. These additional features make the RM Standard suitable for environments with more complex infrastructure requirements.

The third deployment option is the Rack Manager Deluxe (RM Deluxe). This configuration represents the most comprehensive implementation of the rack manager, designed for environments with advanced management requirements. Like the RM Standard, the RM Deluxe is delivered via the x86 delivery model. It includes all the features of the RM Standard (Aggregated API Model, Rack Power, Rack Thermal, Compute Node, Switch, and Event Logs), and adds Liquid Cooling management and Data Visualization capabilities. The Liquid Cooling management feature provides specific controls and monitoring for liquid cooling systems, addressing the unique thermal challenges of such deployments. This is particularly relevant for high-density compute environments or specialized deployments like the liquid-cooled racks 364 shown in FIG. 3. The Data Visualization feature offers graphical representations of rack status and telemetry data, facilitating administrative tasks through a user-friendly interface. These advanced features make the RM Deluxe suitable for environments with specialized cooling requirements or those requiring enhanced visibility into rack operations.

The deployment options presented in FIG. 5 are not exhaustive. The personality-based approach to rack management allows for custom configurations beyond these standard options. As described supra, customers can select specific features based on their unique requirements. This flexibility enables the creation of custom builds with specific feature combinations that may not align with the standard deployment options. For example, a customer might require the Liquid Cooling management feature from the RM Deluxe but not need the Data Visualization capability. The personality-based approach allows for such customization, ensuring that customers only implement and license the features they need.

The deployment options are selected and configured through the cloud platform, as illustrated in FIG. 3 and FIG. 4. Administrators 312 can access the cloud SaaS portal 354, interact with the rack manager personality service 352 or 410, and select the appropriate deployment option based on their specific requirements. The rack manager builder 420 then generates the necessary artifacts, drawing from the core service sources 442, protocols sources 444, and features services 446 to create a rack manager implementation with the desired personality.

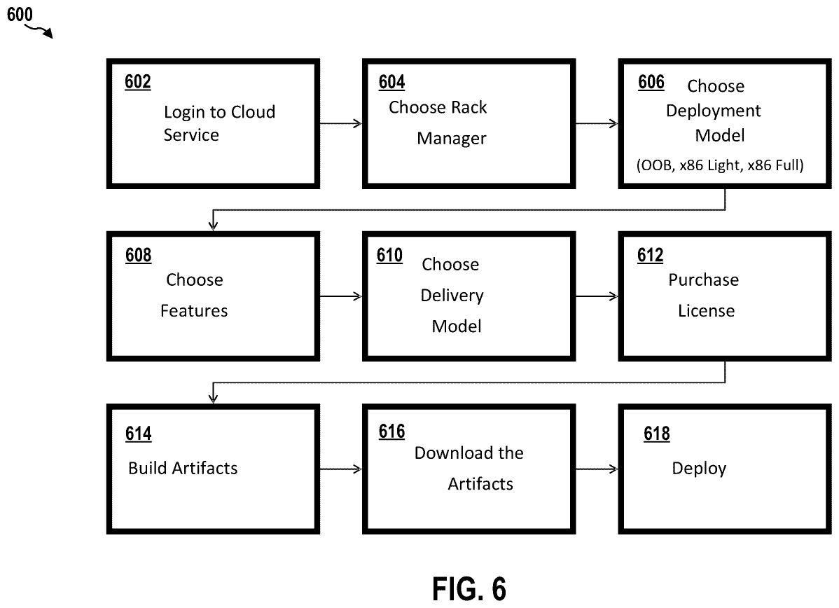

FIG. 6 is a flow chart 600 illustrating a workflow for deploying a personality-based rack manager through a cloud-based service. The workflow begins with a login step 602, where a user accesses the cloud service. This corresponds to an administrator 312 logging into the cloud SaaS portal 354 as shown in FIG. 3. The cloud service provides the interface through which all subsequent configuration and deployment activities are performed.

Following login, the user proceeds to step 604, where they choose the rack manager product. This selection indicates the user's intent to deploy a rack management solution rather than other potential services that might be offered through the cloud platform.

At step 606, the user chooses a deployment model, which corresponds to the options presented in FIG. 5, such as Rack Manager Lite, Rack Manager Standard, or Rack Manager Deluxe. The selection of the deployment model determines the baseline capabilities and the target platform type. Subsequently, at step 608, based on the chosen deployment model and the specific needs of the target rack environment (e.g., racks 362, 364, or 366), the user selects the desired features. This selection is facilitated by the rack manager personality service 410, allowing the user to choose from available features services 446, such as compute node management, liquid cooling support, or specific protocol handling.

At step 610, the user selects the delivery model for the rack manager. The delivery model specifies the format in which the rack management solution will be provided. Options might include firmware (for deployment directly on hardware), binary (for installation on an existing operating system), or container (for deployment in a containerized environment). This selection determines how the rack manager will be packaged and deployed in the target environment.

The user then proceeds to step 612, where they purchase the appropriate license for their configured rack management solution. The licensing is based on the selected features and deployment model, ensuring that customers only pay for the capabilities they need.

Following license acquisition, the system proceeds to step 614, where it builds the artifacts for the rack manager. This process corresponds to the operation of the rack manager builder 420 shown in FIG. 4, which draws upon the core service sources 442, protocols sources 444, and features services 446 to create a customized rack manager implementation. The build process generates a package containing the core service 422, protocols 424, and features 426 specified in the previous configuration steps.

At step 616, the user downloads the generated artifacts from the cloud service. These artifacts represent the customized rack manager implementation, packaged according to the selected delivery model.

Finally, in step 618, the user deploys the downloaded artifacts in their environment. The deployment process varies depending on the selected delivery model. For firmware delivery, the artifacts might be installed as a technology pack on the target hardware. For binary delivery, the artifacts would be installed as an application on an existing operating system. For container delivery, the artifacts would be deployed in a containerized environment.

This workflow addresses the challenge of deployment complexity in heterogeneous data center environments by providing a streamlined, self-service approach to configuring and deploying customized rack management solutions. It enables administrators to tailor the rack manager to their specific requirements and infrastructure constraints, selecting only the features and capabilities they need.

The deployment process accommodates various scenarios in which the rack manager might be situated. As described referring to FIG. 3, the rack manager can be deployed on different types of hardware within a rack, including a TOR switch, a power shelf controller, a dedicated server, or a BMC-like controller. The flexibility of the workflow, combined with the personality-based approach to rack management, allows customers to deploy the rack manager in the location that best suits their operational requirements.

Further, an on-premises deployment model, implemented at steps 616 and 618, may address customer concerns about data security and control. Customers download and deploy the rack management solution locally. Thus, sensitive management data are not exposed to external networks. This approach is particularly important for management solutions that handle critical infrastructure information.

Further, the present disclosure introduces an RRR Hierarchy concept for scalable rack management. The RRR acronym represents Rack, Row, and Room levels of management, though this hierarchical approach is not limited to just these three layers and can be configured according to specific customer requirements. This hierarchical management structure addresses the challenge of scalability in modern data centers by extending the rack management concept beyond individual racks to encompass larger organizational units.

In a typical data center layout, multiple racks are arranged in rows, multiple rows form rooms, and a data center may contain multiple rooms. The RRR Hierarchy allows data center administrators to distribute management responsibilities across these different layers, with each layer handling the appropriate level of aggregation and control. At the foundation is the rack manager 210, which manages individual racks as described in FIG. 2. Above this level is the Row Manager, which aggregates and manages multiple rack managers 210, treating them as a cluster of racks. The Room Manager represents the next level of hierarchy, overseeing multiple Row Managers. At the highest level, a data center management module 201 coordinates activities across all Room Managers within the data center.

This hierarchical approach to rack management maintains a unified source control strategy. Despite the different management layers, the system utilizes one source codebase for all levels, with the rack manager builder 420 generating appropriate binaries based on the selected personality. For the Rack Manager Lite deployment option, both Out-of-Band (OOB) and x86 delivery models are supported, while other variants like Row Manager and Room Manager typically use x86-based delivery due to their increased computational requirements. Importantly, the same binary structure is maintained across all layers, with feature enablement determined by the specific layer's requirements and responsibilities.

The delivery mechanism for different layers of the RRR Hierarchy varies based on the deployment environment. Some implementations may use firmware delivery for embedded systems, while others may employ x86-based application delivery for more complex management scenarios. This variation introduces certain complexities in version management, particularly in maintaining consistency between firmware versions and application versions across the hierarchy. The rack manager personality service 410 addresses these challenges by coordinating version compatibility and ensuring appropriate feature sets are deployed at each level.

From a functionality perspective, each layer in the RRR Hierarchy implements similar core capabilities, including Redfish-based RESTful APIs, Redfish Event Model support, and aggregated APIs that simplify management operations. The system also supports OEM APIs for special metrics that may be specific to particular hardware or environments. Across all layers, there is a focus on power and thermal management, which are critical aspects of data center operations. However, feature availability may vary by layer, with certain capabilities limited at the BMC level due to resource constraints, while more extensive aggregation features are available at higher levels in the hierarchy.

Device communication within the RRR Hierarchy employs several sophisticated mechanisms. Automatic discovery of manageable devices utilizes protocols such as Link Layer Discovery Protocol (LLDP) and Simple Service Discovery Protocol (SSDP), enabling each management layer to identify and incorporate devices under its purview. The system implements global authentication to maintain security across the hierarchy, while supporting multiple management protocols including Redfish, IPMI, and SNMP to accommodate diverse hardware environments. The system may maintain permanent device connectivity. Redfish Event Subscription capabilities enable event-driven management responses. The architecture also provides abstraction in device connectivity, implementing secure communication channels that protect management traffic from unauthorized access.

Data handling within the RRR Hierarchy emphasizes aggregation and abstraction. Each layer aggregates data from the layers below it, providing consolidated information to higher levels while preserving access to detailed data when needed. Data abstraction mechanisms present information in consistent formats regardless of the underlying hardware diversity. The system assigns unique identifiers to resource instances at the rack level, providing unambiguous reference to specific components even in complex environments with multiple similar devices.

The RRR Hierarchy is designed with extensibility as a core principle. It supports new Redfish API implementations with minimal or no configuration changes, allowing the management system to evolve as standards develop. Comprehensive event logs and notifications provide visibility into system operations across all hierarchy levels. The architecture facilitates easy integration with Data Center Management (DCM) or Data Center Infrastructure Management (DCIM) solutions, allowing the RRR Hierarchy to function as part of broader management ecosystems.

This hierarchical approach may provide scalability by distributing management responsibilities across appropriate layers. The system accommodates technology heterogeneity through flexible protocol support, simplifies deployment through the personality-based approach implemented via the rack manager personality service 410 and rack manager builder 420, and enables customized feature sets at each level of the hierarchy.

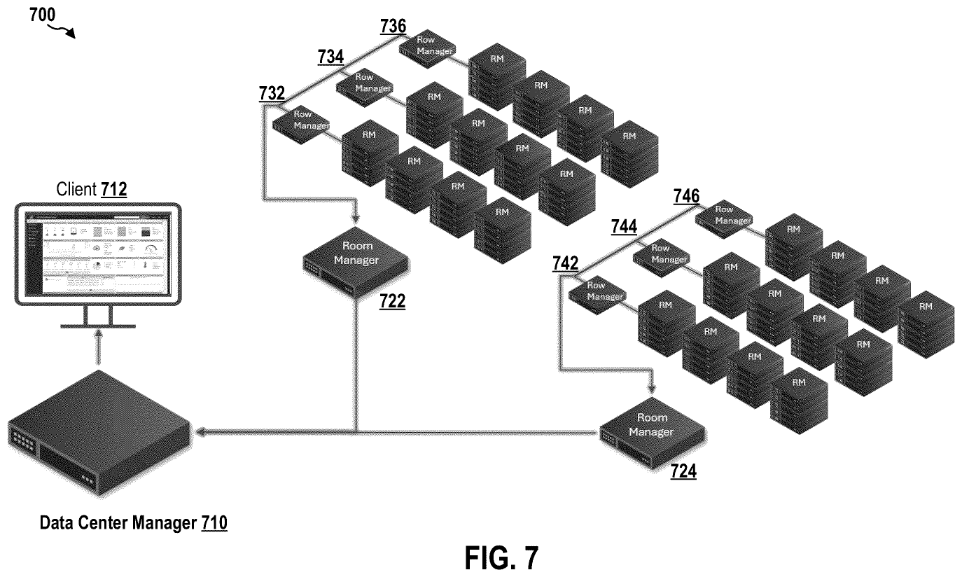

FIG. 7 is a diagram 700 illustrating a hierarchical data center management system implementing the RRR (Rack, Row, Room) management architecture. This diagram provides a comprehensive visualization of how the personality-based rack management system scales across multiple organizational levels within a data center environment, from individual rack managers to the data center level.

At the foundation of this hierarchical system is the data center manager 710. The data center manager 710 serves as the central control point for the entire management infrastructure, providing a unified interface through which administrators can monitor and control all aspects of the data center environment. Connected to the data center manager 710 is a client 712, which allows operators to interact with the system through a graphical dashboard that presents aggregated information from all subordinate management layers.

In this example, the data center manager 710 communicates bidirectionally with two room managers: room manager 722 and room manager 724. These room managers represent the highest tier in the RRR hierarchy beneath the data center level, each responsible for overseeing operations within a distinct physical section of the data center. The room manager 722 and room manager 724 function as aggregation points that collect and process information from multiple row managers beneath them, while also implementing room-level policies for power allocation, thermal management, and security.

In this example, the room manager 722 communicates with three row managers: row manager 732, row manager 734, and row manager 736. Similarly, the room manager 724 communicates with three row managers: row manager 742, row manager 744, and row manager 746. Each row manager supervises a collection of racks arranged in a physical row within the data center, representing the middle tier of the RRR hierarchy. These row managers aggregate data from individual rack managers and implement row-specific management policies, such as coordinated power allocation across multiple racks or thermal management strategies that consider the entire row as a unified thermal entity.

At the most granular level of the management hierarchy are the rack managers (labeled as RM in the diagram), multiple instances of which connect to each row manager. These rack managers correspond functionally to the rack manager 210 described in FIG. 2, incorporating components such as the discovery/location component 211, BMC proxy/firewall component 212, health component 213, power/thermal component 214, composition component 215, telemetry/aggregation component 216, firmware update component 217, and attestation/security component 218. Each rack manager directly controls and monitors the infrastructure components within a single rack, including compute nodes, networking equipment, storage devices, and/or cooling systems.

The hierarchical structure depicted in FIG. 7 demonstrates the scalability of the personality-based rack management approach. This architecture is not strictly limited to three tiers (Rack, Row, Room) but can be adapted to the specific organizational requirements of any data center environment. The communication pathways shown between tiers represent bidirectional data flows that enable both top-down command propagation and bottom-up status reporting.

The scalability issue may be resolved through the hierarchical distribution of management responsibilities, where each layer handles an appropriate scope of components. For example, a rack manager might focus on the health and performance of individual servers, while a row manager coordinates power allocation strategies across multiple racks, and a room manager implements broader thermal management policies across multiple rows.

The system depicted in FIG. 7 also facilitates multi-tenancy management, particularly valuable in colocation data centers where different customers may occupy distinct physical sections of the facility. The room managers can isolate management domains to prevent unauthorized access between tenants, while the data center manager 710 can still collect aggregated metrics for facility-wide operations such as Power Usage Effectiveness (PUE) calculations.

The implementation of this hierarchy uses the personality-based approach described previously. Each management entity (rack manager, row manager, room manager) can be deployed with a specific personality that defines its feature set, deployment location, and management focus. These personalities are created through the rack manager personality service 410 and built by the rack manager builder 420, drawing from the same underlying source code repositories (core service sources 442, protocols sources 444, and features services 446) but with feature enablement appropriate to each hierarchical level.

For example, a rack manager might focus on detailed hardware monitoring and control, a row manager might emphasize power distribution optimization across racks, and a room manager might prioritize thermal management and security isolation between tenant domains. Despite these different focus areas, all management entities maintain a consistent operational framework through standardized protocols and APIs, facilitating seamless vertical integration.

The example in the diagram 700 illustrates the hierarchical data center management system implementing the RRR (Rack, Row, Room) management architecture, showcasing its scalability and flexibility. While the diagram depicts a full hierarchy with a data center manager 710 communicating through room managers (e.g., a room manager 722 and a room manager 724) and row managers (e.g., a row manager 732, a row manager 734, a row manager 736, a row manager 742, a row manager 744, and a row manager 746) down to individual rack managers (RM), the architecture supports adaptable deployment configurations. The data center manager 710 is not limited to interacting solely with the highest subordinate tier, such as the room managers 722 and 724. Instead, the data center manager 710 possesses the capability to establish direct communication links and exercise control over managers at any level within the hierarchy. This means the data center manager 710 can connect directly to and manage not only the room managers 722 and 724, but also any of the row managers (e.g., 732, 742) or even individual rack managers (RM) directly, bypassing intermediate layers if required by the specific deployment topology or management task.

This inherent flexibility allows for various implementation scenarios tailored to the scale and complexity of the data center environment. For instance, in certain implementations, the hierarchy might be flattened, utilizing only the rack managers (RM). In such a configuration, the data center manager 710 would communicate directly with each rack manager (RM), providing centralized management without the need for intermediate aggregation layers like row or room managers. This approach might be suitable for smaller data centers or specific clusters where the overhead of additional management tiers is unnecessary.

In other implementations, a two-tier hierarchy might be employed, consisting of only rack managers (RM) and row managers (e.g., 732-736, 742-746). In this scenario, the room managers 722 and 724 would not be deployed. The data center manager 710 would then communicate directly with the row managers, which in turn aggregate information from and manage the rack managers within their respective rows. This configuration provides an intermediate level of aggregation and control suitable for medium-sized deployments or environments organized primarily by rows. The ability to select the appropriate hierarchical depth (e.g., R, RR, or RRR) is integral to the personality-based deployment model, configured via interfaces like the cloud SaaS portal 354 and the rack manager personality service 410, allowing administrators 312 to define the management structure that best fits their operational needs. The underlying communication protocols and aggregated API models facilitate these varied connection patterns within the management framework.

Further extending the flexibility described in relation to FIG. 4 and the RRR Hierarchy concept, the rack manager builder 420 is not limited to constructing only rack manager (RM) instances. The same underlying architecture and build process can be utilized to generate management instances for higher levels of the data center hierarchy, specifically a row manager (such as the row manager 732 or the row manager 742) and a room manager (such as the room manager 722 or the room manager 724) as depicted in FIG. 7. When an administrator 312 interacts with the rack manager personality service 410 via the cloud SaaS portal 354, they can specify the desired hierarchical role (Rack, Row, or Room) as part of the personality definition, in addition to selecting features and deployment models.

Based on this specified role, the rack manager builder 420 orchestrates the build process accordingly. It draws upon the common repositories, including the core service sources 442, the protocols sources 444, and the features services 446. However, the selection and configuration of the microservices, particularly the features 426 included in the final artifact, are tailored to the responsibilities of the designated hierarchical level. For instance, when building a row manager or a room manager, the rack manager builder 420, guided by appropriate recipes (e.g., the x86 recipes 434, as these higher-level managers often require more computational resources), would select and integrate features 426 from the features services 446 that emphasize aggregation, policy enforcement across multiple subordinate managers, and potentially different data handling or visualization capabilities compared to a standard rack manager (RM). While a rack manager (RM) personality might focus on direct device communication (using protocols 424 like Redfish, IPMI, SNMP) and fine-grained control of components within a single rack, the row manager and the room manager personalities would incorporate features 426 focused on managing the rack managers (RM) or row managers below them, aggregating telemetry data (utilizing the telemetry/aggregation component 216 concept at a higher scale), and providing abstracted views suitable for managing larger segments of the data center infrastructure.

This unified approach, where the rack manager builder 420 serves as the construction engine for all levels of the RRR hierarchy, leverages a single source control strategy, as mentioned in the RRR discussion. It allows the firmware provider to maintain a consistent codebase while delivering tailored management solutions for diverse scalability requirements. The resulting artifacts, whether for a rack manager (RM), a row manager, or a room manager, share a common architectural foundation derived from the core service 422 but possess distinct personalities defined by the specific features 426 enabled for their respective roles within the overall data center management structure illustrated in FIG. 7. This capability streamlines development, updates, and maintenance across the entire management hierarchy.

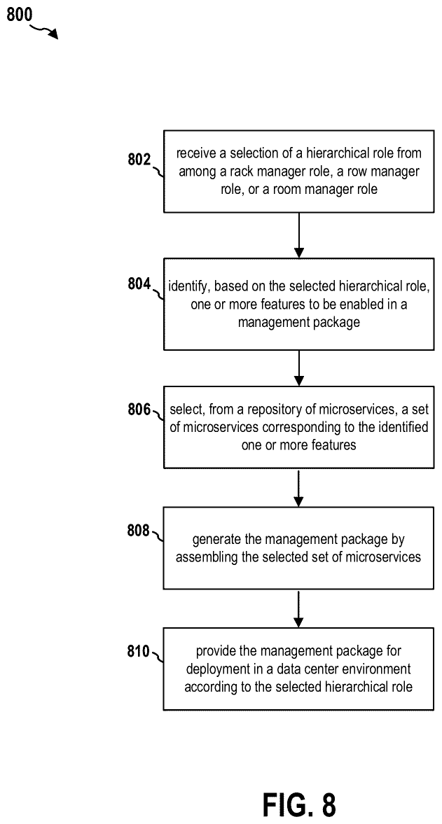

FIG. 8 is a flow chart 800 of a method (process) for generating and providing a personality-based management package for a data center environment. The method may be performed by one or more computing devices (e.g., the cloud-based system comprising the rack manager personality service 410 and the rack manager builder 420 described in FIG. 4).

In certain configurations, the one or more computing devices provide a user interface through a cloud-based service (e.g., cloud SaaS portal 354).

In operation 802, the one or more computing devices receive a selection of a hierarchical role from among a rack manager role, a row manager role, or a room manager role. In certain configurations, receiving the selection of the hierarchical role comprises receiving the selection through the user interface provided via the cloud-based service.

In certain configurations, the one or more computing devices receive a selection of a deployment model for the management package. In certain configurations, the deployment model is selected from a group of deployment models each containing a different collection of components (e.g., RM Lite, RM Standard, RM Deluxe as shown in FIG. 5).

In operation 804, the one or more computing devices identify, based on the selected hierarchical role, one or more features to be enabled in a management package. In certain configurations where a deployment model is selected, identifying the one or more features is further based on the selected deployment model. In certain configurations, the one or more features include at least one of: an aggregated API model, rack power management, rack thermal management, compute node management, switch management, liquid cooling management, event logging, web user interface, or data visualization.

In certain configurations, the one or more computing devices receive a selection of one or more communication protocols to be supported by the management package. In certain configurations, the one or more communication protocols include at least one of: Redfish, Intelligent Platform Management Interface (IPMI), Simple Network Management Protocol (SNMP), Modbus, Serial, or Secure Shell (SSH).

In operation 806, the one or more computing devices select, from a repository of microservices (e.g., core service sources 442, protocols sources 444, features services 446), a set of microservices corresponding to the identified one or more features.

In certain configurations, the one or more computing devices determine a deployment location for the management package. In certain configurations, the deployment location includes at least one of: a top-of-rack switch, a power shelf, a dedicated rack management server, a DC-SCM controller, or a baseboard management controller (BMC).

In certain configurations, the one or more computing devices receive a selection of a delivery model for the management package. In certain configurations, the delivery model is selected from a group consisting of: a firmware image, a binary package, and a container image.

In operation 808, the one or more computing devices generate the management package by assembling the selected set of microservices. To generate the management package, the one or more computing devices select a recipe (e.g., ARM recipes 432, x86 recipes 434) corresponding to a target hardware platform for the management package, where the recipe includes instructions for building an image for the target hardware platform. The one or more computing devices use the recipe to guide integration of the selected set of microservices into the management package. In certain configurations, the target hardware platform comprises at least one of: an ARM-based platform or an x86-based platform. In certain configurations where a delivery model is selected, to generate the management package, the one or more computing devices package the selected set of microservices according to the selected delivery model. In certain configurations where a deployment location is determined, the one or more computing devices customize the management package based on the deployment location. In certain configurations, the management package includes a core service component (e.g., core service 422) that provides foundational functionality common across all hierarchical roles, and the selected set of microservices are integrated with the core service component. In certain configurations, the management package includes protocol implementations corresponding to the selected one or more communication protocols.

In certain configurations, the one or more computing devices generate a license for the management package based on the identified one or more features. The one or more computing devices associate the license with the management package prior to providing the management package.

In operation 810, the one or more computing devices provide the management package for deployment in a data center environment according to the selected hierarchical role. In certain configurations, providing the management package comprises making the management package available for download through the cloud-based service.

In certain configurations, the hierarchical role is the rack manager role, and the management package is configured to manage components within a rack including at least one of: compute nodes, networking equipment, storage devices, or cooling systems. In certain configurations, the hierarchical role is the row manager role, and the management package is configured to manage a plurality of rack managers. In certain configurations, the hierarchical role is the room manager role, and the management package is configured to manage a plurality of row managers.

In certain configurations, the one or more computing devices receive a request to update the management package with an additional feature. The one or more computing devices select, from the repository of microservices, an additional microservice corresponding to the additional feature. The one or more computing devices generate an updated management package by integrating the additional microservice with the management package. The one or more computing devices provide the updated management package for deployment.

The various management components detailed in FIGS. 2-8, such as the rack manager (210, RM), row manager (e.g., 732), room manager (e.g., 722), and data center manager (201, 710), represent software entities that require a computing platform for execution. The host computer 180 depicted in FIG. 1 provides a suitable architectural example for implementing these management roles, particularly when deployed as dedicated management servers. In such implementations, the management software, potentially built as a specific personality using the microservices architecture (FIG. 4) and workflow (FIG. 6), would run as an application or set of applications on the host OS 194, utilizing the host CPU 182, host memory 184, and storage device(s) 185 for its operations, and communicating over a network connected via interfaces such as those within component devices 186 or potentially leveraging the BMC's network interface card 119 if configured appropriately for management traffic passthrough or dedicated use.

Furthermore, while the host computer 180 architecture serves as a representative platform for the primary management software instances (especially for Standard/Deluxe or Row/Room/Data Center managers requiring more resources), other elements of the system may utilize similar computing structures. The cloud-based components like the SaaS portal (354), rack manager personality service (352, 410), and rack manager builder (420) may execute on remote server infrastructure, including multiple machines with architectures analogous to the host computer 180, accessible over networks (170, 172). Conversely, simpler management personalities (e.g., RM Lite) or specific functions might be deployed on more constrained hardware such as a TOR switch, power shelf controller, or even the BMC 102 itself, using its processor (112), memory (114), and storage (117) or equivalents. Administrator workstations (312) or clients (712) interacting with the system would also be computing devices, potentially similar to the host computer 180 or the remote device 175.

It is understood that the specific order or hierarchy of blocks in the processes / flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, the method comprising:
receiving a selection of a hierarchical role from among a rack manager role, a row manager role, or a room manager role;
identifying, based on the selected hierarchical role, one or more features to be enabled in a management package;
selecting, from a repository of microservices, a set of microservices corresponding to the identified one or more features;
generating the management package by assembling the selected set of microservices; and
providing the management package for deployment in a data center environment according to the selected hierarchical role.

2. The method of claim 1, wherein the hierarchical role is the rack manager role, and wherein the management package is configured to manage components within a rack including at least one of: compute nodes, networking equipment, storage devices, or cooling systems.

3. The method of claim 1, wherein the hierarchical role is the row manager role, and wherein the management package is configured to manage a plurality of rack managers.

4. The method of claim 1, wherein the hierarchical role is the room manager role, and wherein the management package is configured to manage a plurality of row managers.

5. The method of claim 1, further comprising:
receiving a selection of a deployment model for the management package, wherein the deployment model is selected from a group of deployment models each containing a different collection of components; and
wherein identifying the one or more features is further based on the selected deployment model.

6. The method of claim 1, further comprising:
receiving a selection of a delivery model for the management package, wherein the delivery model is selected from a group consisting of: a firmware image, a binary package, and a container image; and
wherein generating the management package includes packaging the selected set of microservices according to the selected delivery model.

7. The method of claim 1, further comprising:
receiving a selection of one or more communication protocols to be supported by the management package, wherein the one or more communication protocols include at least one of: Redfish, Intelligent Platform Management Interface (IPMI), Simple Network Management Protocol (SNMP), Modbus, Serial, or Secure Shell (SSH); and
including, in the management package, protocol implementations corresponding to the selected one or more communication protocols.

8. The method of claim 1, wherein the one or more features include at least one of:
an aggregated API model, rack power management, rack thermal management, compute node management, switch management, liquid cooling management, event logging, web user interface, or data visualization.

9. The method of claim 1, further comprising:
determining a deployment location for the management package, wherein the deployment location includes at least one of: a top-of-rack switch, a power shelf, a dedicated rack management server, a DC-SCM controller, or a baseboard management controller (BMC); and
customizing the management package based on the deployment location.

10. The method of claim 1, further comprising:
providing a user interface through a cloud-based service;
wherein receiving the selection of the hierarchical role comprises receiving the selection through the user interface; and
wherein providing the management package comprises making the management package available for download through the cloud-based service.

11. The method of claim 1, further comprising:
generating a license for the management package based on the identified one or more features; and
associating the license with the management package prior to providing the management package.

12. The method of claim 1, wherein generating the management package comprises:
selecting a recipe corresponding to a target hardware platform for the management package, wherein the recipe includes instructions for building an image for the target hardware platform; and
using the recipe to guide integration of the selected set of microservices into the management package.

13. The method of claim 12, wherein the target hardware platform comprises at least one of: an ARM-based platform or an x86-based platform.

14. The method of claim 1, further comprising:
receiving a request to update the management package with an additional feature;
selecting, from the repository of microservices, an additional microservice corresponding to the additional feature;
generating an updated management package by integrating the additional microservice with the management package; and
providing the updated management package for deployment.

15. The method of claim 1, wherein the management package includes a core service component that provides foundational functionality common across all hierarchical roles, and wherein the selected set of microservices are integrated with the core service component.

16. A system, including one or more computing devices, comprising:
a memory; and
at least one processor coupled to the memory and configured to:
receive a selection of a hierarchical role from among a rack manager role, a row manager role, or a room manager role;
identify, based on the selected hierarchical role, one or more features to be enabled in a management package;
select, from a repository of microservices, a set of microservices corresponding to the identified one or more features;
generate the management package by assembling the selected set of microservices; and
provide the management package for deployment in a data center environment according to the selected hierarchical role.

17. The system of claim 16, wherein the hierarchical role is the rack manager role, and wherein the management package is configured to manage components within a rack including at least one of: compute nodes, networking equipment, storage devices, or cooling systems.

18. The system of claim 16, wherein the hierarchical role is the row manager role, and wherein the management package is configured to manage a plurality of rack managers.

19. The system of claim 16, wherein the hierarchical role is the room manager role, and wherein the management package is configured to manage a plurality of row managers.

20. A non-transitory computer-readable medium storing computer executable code for operating one or more computing devices, comprising code to:
receive a selection of a hierarchical role from among a rack manager role, a row manager role, or a room manager role;
identify, based on the selected hierarchical role, one or more features to be enabled in a management package;
select, from a repository of microservices, a set of microservices corresponding to the identified one or more features;
generate the management package by assembling the selected set of microservices; and
provide the management package for deployment in a data center environment according to the selected hierarchical role.
